(19) United States
(12) Patent Application Publication
(10) Pub. No.: US 2006/0180609 A1
(43) Pub. Date: Aug. 17, 2006

(54) Apparatus for pipetting power

(76) Inventors: David Clarence Hager, San Francisco, CA (US); Patrick Kearney, San Francisco, CA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/527,230

(22) PCT Filed: Sep. 8, 2003
(86) PCT No.: PCT/US03/28039

§ 371 Date: Sep. 26, 2005

Related U.S. Application Data
(60) Provisional application No. 60/410,568, filed on Sep. 13, 2002.

(51) Int. Cl. B67D 5/56

(52) U.S. Cl. 222/129

(57) ABSTRACT

The present invention provides apparatus and methods for collecting a plurality of measured quantities of a powdered material and dispensing each of the measured quantities to, for example, a multi-well vessel. Vacuum is used to collect the powdered material and at least one of gravity, a gas push, or a physical push is used to dispense the powdered material. Apparatus and methods of the invention are particularly useful for collection and delivery of powdered materials in high throughput chemical synthesis and biological assay environments where accurate measurement and dispensing of powders is critical.

### BACKGROUND OF THE INVENTION

1. Field of the Invention

This invention relates to apparatus and methods for handling small-particle size solid materials, such as powders, granules, beads, and the like. More specifically, the invention relates to apparatus and methods for collecting and dispensing powdered materials for high throughput applications, such as those using multi-well apparatus, as in chemical, biological, and biochemical research.

2. Summary of Related Art

There are many arts that require measurement and dispensing of a defined quantity of a powder. Technological arts such as pharmaceutical manufacturing, powder coating, confection manufacturing, powder metallurgy, cosmetics, spices, and flavorings are some examples.

There is an especially important need for efficient powder measuring and dispensing for arts that use multi-well format vessels such as those used in high throughput chemical synthesis, bioassays, and the like. For example, in combinatorial chemical synthesis, a measured amount of a powdered reagent or resin is often added to each of a plurality of reaction wells in, for example, a 96-well format reactor. With continually improving technology, these multi-well reactors (and assay plates) are becoming smaller and smaller, and thus the amount of powdered material needed for each well is steadily becoming smaller and smaller. Therefore, for high throughput applications, there is a need for apparatus and methods for accurately adding small measured amounts of powdered reagents or resins simultaneously to each of a plurality of wells.

Another need in the art, for example in commercial combinatorial chemistry efforts, is for more accurate dispensing of moderately small sized (on the order of grams and/or fractions of grams) amounts of solid resins. For example, a trend in modern combinatorial chemistry is to make tens to hundreds (or even thousands) of milligrams of a number of individual compounds, and to purify the compounds in a high-throughput fashion. In order to control stoichiometries of the corresponding formation reactions, the resins used for the reactions must be accurately quantitatively dispensed simultaneously to each of a plurality of wells.

There are conventional apparatus that one can employ for retrieving and delivering small measured amounts of powdered solids. For example, the DryPette® powder pipette (available from Zinsser Analytic of Frankfurt Germany) is capable of collecting a measured volume of a powder and expelling it. However, this pipette system only handles a single dose of solid at one time. In order to deliver a plurality of doses, to for example a 96-well plate, requires the user to perform 96 retrieve-and-dispense operations. As well, there is significant room for user error (e.g. cross-contamination and/or dispensing to the wrong well) when pipetting to a multi-well vessel because the wells are arranged contiguously.

There is at least one conventional apparatus for dispensing small measured amounts of powdered reagents or resins simultaneously to each of a plurality of wells in a multi-well format vessel. The MiniBlock Resin Dispenser® (available from Mettler-Toledo Bohdan, Inc. of Vernon Hills, Ill.) is used to dispense pre-measured amounts of resins and powders to all wells of a multi-well vessel. This apparatus uses a measuring plate system, a top plate having a plurality of fixed-volume holes (each corresponding to each well of a multi-well vessel) slidably engage-able with a bottom plate. When engaged, the plates form a plurality of fixed volume cavities that must be hand loaded by scraping resin across the top plate to fill the cavities. Once filled, the bottom plate is removed, and gravity is used to dispense resin from each of the holes and into each corresponding well of a multi-well vessel. To vary the amount of resin measured, the user must choose a top plate with appropriately sized measuring holes.

Although the MiniBlock Resin Dispenser® allows for measurement and addition of powdered solids to all wells of a multi-well vessel, there are inherent problems with this approach. For example, since the holes are filled via manual scraping of solid material across a measuring plate, there can be variation in the level of compaction of the solid material in each of the cavities. This leads to variation in the amount of solid added to each well. Additionally, since the cavities are filled from the top, the excess powder must be scraped off of the plate each time and returned to a bulk supply used for filling the plates successively. This is manually intensive and time consuming, a problematic situation, especially in a high-throughput environment. Finally, in order to fill different wells of a given multi-well vessel with different amounts of resin, a user would either have to switch out plates during the addition process (using only a portion of each plate's holes for each measure/dispense operation) or manufacture plates with varying hole bore, depending on the need. The former scenario presents significant cross contamination issues (e.g. when loading a variety of reagents) and the latter significant up-front time and material commitment.

What is needed therefore are apparatus and methods for simultaneously and automatically collecting and measuring a plurality of measured quantities of a powdered material and delivering each measured quantity simultaneously to a corresponding receiving vessel. Particularly apparatus that allow such operations for all wells or a subset of wells of a given multi-well vessel, without manually changing out components of the apparatus.

### SUMMARY OF THE INVENTION

The present invention provides apparatus and methods for collecting, substantially simultaneously, a plurality of measured quantities of a powdered material and dispensing, substantially simultaneously, each of the measured quantities to, for example, a multi-well vessel. Vacuum is used to collect the powdered material and at least one of gravity, a gas push, or a physical push is used to dispense the powdered material. Apparatus and methods of the invention are particularly useful for collection and delivery of powdered materials in high throughput chemical synthesis and biological assay environments.

One aspect of the invention is an apparatus for automatically collecting, substantially simultaneously, a plurality of measured quantities of a powdered material and dispensing, substantially simultaneously, each of the plurality of measured quantities of the powdered material. Such apparatus may be characterized by the following aspects: a plurality of collection cavities, each of the collection cavities including an inlet for fluid communication therein and a filter configured to prevent the powdered material from entering a vacuum source; said vacuum source connected to each of the plurality of collection cavities via the inlet therein; and a control valve configured to establish or terminate fluid communication between the vacuum source and each of the plurality of collection cavities. Also preferably apparatus of the invention include a plurality of valves for controlling fluid communication between at least the vacuum source and all or a sub-set of the plurality of collection cavities.

Preferably the volume of each of the plurality of collection cavities is dynamically adjustable. Also preferably, each of the plurality of collection cavities is capable of holding between about 0.005 cm³ and 2 cm³ of the powdered material, more preferably between about 0.01 cm³ and 1 cm³ of the powdered material, and most preferably between about 0.1 cm³ and 0.5 cm³ of the powdered material. Preferably, apparatus of the invention are capable of collecting each of the measured quantities of the powdered material to within about ±0.1 cm³, more preferably to within about ±0.005 cm³, and most preferably between about ±0.001 cm³.

In a particularly preferred embodiment, the plurality of collection cavities are configured on a collection member such that when the collection member is registered with a multi-well vessel, each cavity of the plurality of collection cavities is positioned to dispense its corresponding quantity, of the plurality of measured quantities of powdered material, into a corresponding well of the multi-well vessel. Preferably the multi-well vessel includes at least one of an 8-well format vessel, a 24-well format vessel, a 96-well format vessel, a 384-well format vessel, and a 1536-well format vessel. In a particularly preferred embodiment, the collection member includes a plurality of holes, the plurality of holes slidably engage-able with; a plurality of plungers, each of the plurality of plungers including a tube, open at both ends, the aforementioned filter affixed at the end (or integral to the plunger, e.g. if the plunger and filter are made as one piece, e.g. via an injection mold process) of the tube in proximity to the powdered material during collection and the other end of the tube in fluid communication with the vacuum source. Thus the “face” of the plunger, is the end of the tube with the filter affixed to it or the filter defines the end of the tube (is part of the tube, supra). Additionally, the filter may be part of an assembly that engages with the tube to form the “plunger.”

Preferably the volume of each collection cavity is defined substantially by the volume from the aperture of its corresponding hole to the face of its corresponding plunger. In preferred embodiments, an adjustment mechanism is used to dynamically adjust the volume of the collection cavities prior to or during collection of a powder. Preferably the adjustment mechanism includes at least one of a lead screw, a pneumatic cylinder, and a flexible-membrane. In an alternative embodiment, collection cavity inserts are used to adjust the collection cavity volume. Such inserts are particularly useful when they include the filter (e.g. as an assembly) as mentioned above. In one embodiment an insert that engages with the tube is used, one surface of the insert serving as the plunger face (which comprises the filter).

Most preferably apparatus of the invention include a controller, the controller including: a plurality of solenoids for controlling the control valve and the plurality of valves; the vacuum source; a positive pressure source for delivering a positive pressure of a gas; and an associated logic configured to automatically control the plurality of solenoids based on a manual switch control, a pre-programmed algorithm, or both. Preferably the control valve, the plurality of valves, and combinations thereof are used to control fluid communication between each of the collection cavities, via their respective inlets, and either the vacuum source or the positive pressure source. Apparatus of the invention can include a hand held collection member wherein the controller is a remote controller, as well as fully automated apparatus for carrying out methods of the invention (infra) without the need for manual manipulation of the collection member.

In a preferred embodiment, apparatus of the invention include a supply bin for holding the powdered material, the supply bin including: a powder compartment sized and shaped to accommodate a supply of the powdered material and the collection member when collecting the powdered material in the plurality of collection cavities therein; and a squeegee configured to remove at least a portion of the powdered material that protrudes beyond the aperture of each of the plurality of collection cavities, during collection, when the aperture of each of the plurality of collection cavities and the squeegee are moved across one another. Preferably the supply bin is configured such that the portion of the powdered material that protrudes beyond the aperture of each of the plurality of collection cavities, after removed by the squeegee, is returned into the powder compartment or collected in a powder catch compartment.

Another aspect of the invention is a method of collecting and dispensing a powdered material. Such methods may be characterized by the following aspects: collecting, substantially simultaneously, a plurality of measured quantities of the powdered material in a plurality of collection cavities, wherein each of the plurality of collection cavities is in fluid communication with, via an inlet within each cavity, a vacuum source; and dispensing, substantially simultaneously, the plurality of measured quantities of the powdered material by terminating, substantially simultaneously, fluid communication between each of the plurality of collection cavities and the vacuum source while each of the plurality of collection cavities is oriented such that gravity pulls each of the plurality of measured quantities of the powdered material out of each of the plurality of collection cavities. Preferably each of the plurality of collection cavities includes a filter to substantially prevent the powdered solid from entering the inlet.

In a preferred embodiment, the volume of each of the plurality of collection cavities is dynamically adjusted during collection of the powdered material. Methods of the invention may further include applying a positive pressure of a gas to each of the collection cavities, via the inlet within each cavity, to facilitate removal of each of the plurality of measured quantities of the powdered material. Preferably the gas includes at least one of air and an inert gas.

Preferred methods of the invention include moving a squeegee and the aperture of each of the plurality of collection cavities across each other, to remove at least a portion of the powdered material that protrudes beyond the aperture of each of the plurality of collection cavities, after collection and before dispensing.

Methods of the invention are particularly suited for apparatus of the invention as described above. In particular, methods of the invention may be carried out using all or a sub-set of the plurality of collection cavities as described. Particularly preferred methods of the invention include using either a hand-held unit, the hand held unit including the plurality of collection cavities or an automated mechanism. Preferably such an automated mechanism is configured to collect the powdered material in all or the sub-set of the plurality of collection cavities, move the aperture of each of the plurality of collection cavities and the squeegee across one another, and deliver each of the plurality of measured quantities of the powdered solid, via the plurality of collection cavities, to a plurality of vessels corresponding to all or the sub-set of the plurality of collection cavities containing the powdered material.

These and other more detailed aspects of the invention are described below in relation to the following figures.

### BRIEF DESCRIPTION OF THE DRAWINGS

FIG. 1 is a top perspective of a resin handler of the invention.

FIG. 2 is a bottom perspective of the resin handler depicted in FIG. 1.

FIG. 3 is a top view of the resin handler depicted in FIG. 1, indicating side view cross sections corresponding to FIGS. 4 and 5.

FIG. 4 is a side view cross section of the resin handler as indicated in FIG. 3.

FIG. 4A depicts a detailed portion of the side view cross section of the resin handler in FIG. 4.

FIG. 5 is a side view cross section of the resin handler as indicated in FIG. 3.

FIG. 6 is a top perspective of the resin handler engaged with a 96-well vessel.

FIG. 7 is a cross section of the resin handler engaged with a 96-well vessel as indicated in FIG. 6.

FIGS. 8A and 8B depict a supply bin of the invention without and with a lid, respectively.

FIG. 9 is a flowchart depicting aspects of a process flow in accordance with the invention.

### DETAILED DESCRIPTION OF THE INVENTION

In the following detailed description of the present invention, numerous specific embodiments are set forth in order to provide a thorough understanding of the invention. However, as will be apparent to those skilled in the art, the present invention may be practiced without these specific details or by using alternate elements or processes. In other instances well-known processes, procedures and components have not been described in detail so as not to unnecessarily obscure aspects of the present invention.

As mentioned, the invention provides apparatus and methods for collecting, substantially simultaneously, a plurality of measured quantities of a powdered material and dispensing, substantially simultaneously, each of the measured quantities to, for example, a multi-well vessel. Vacuum is used to collect the powdered material and at least one of gravity, a gas push, or a physical push is used to dispense the powdered material. Apparatus and methods of the invention are particularly useful for collection and delivery of powdered materials in high throughput chemical synthesis and biological assay environments. In the following detailed description of an embodiment of the invention, reference numbers are carried through the figures as appropriate. The following is a description of a particularly preferred embodiment of the invention and is not intended to limit the scope of the invention.

Definitions

As used in the present specification, the following words and phrases are generally intended to have the meanings as set forth below, except to the extent that the context in which they are used indicates otherwise.

In this application the term “powder” or “powdered material” is meant to mean small-particle size solid materials, such as powders, granules, beads, and the like. Small-particle size materials generally have an average particle diameter on the order of between about 5 μm and 1000 μm, although smaller and larger particles are meant to fall within the scope of the invention.

In this application the term “dynamically adjustable” is meant to mean a mechanism of an apparatus of the invention that can be adjusted or otherwise controlled without having to change out components or add components to the apparatus that includes the mechanism.

In this application the term “squeegee” is meant to mean a mechanism used to remove a portion of a measured quantity of a powdered material collected via a collection cavity. In an exemplary resin handler described below, a squeegee is described as a mechanical member used to remove (e.g. via drawing the squeegee and a collection member across one another) a portion of a measured quantity of a collected powder that protrudes beyond the aperture of such a collection cavity. It is understood by one skilled in the art that a “squeegee” may also include other mechanisms for powder removal such as a jet of air (air knife) and the like. Additionally, removal by a squeegee of the invention may include removal of a portion of a measured quantity of powdered material from within such a collection cavity (from an area within the aperture of the collection cavity).

Resin Handler

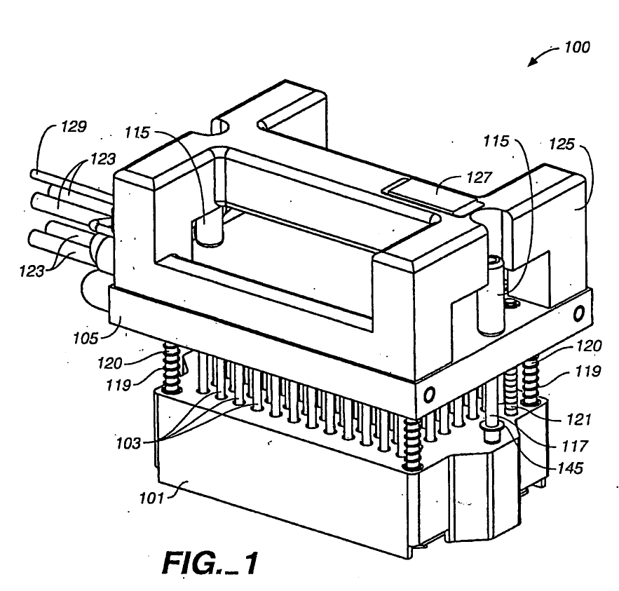

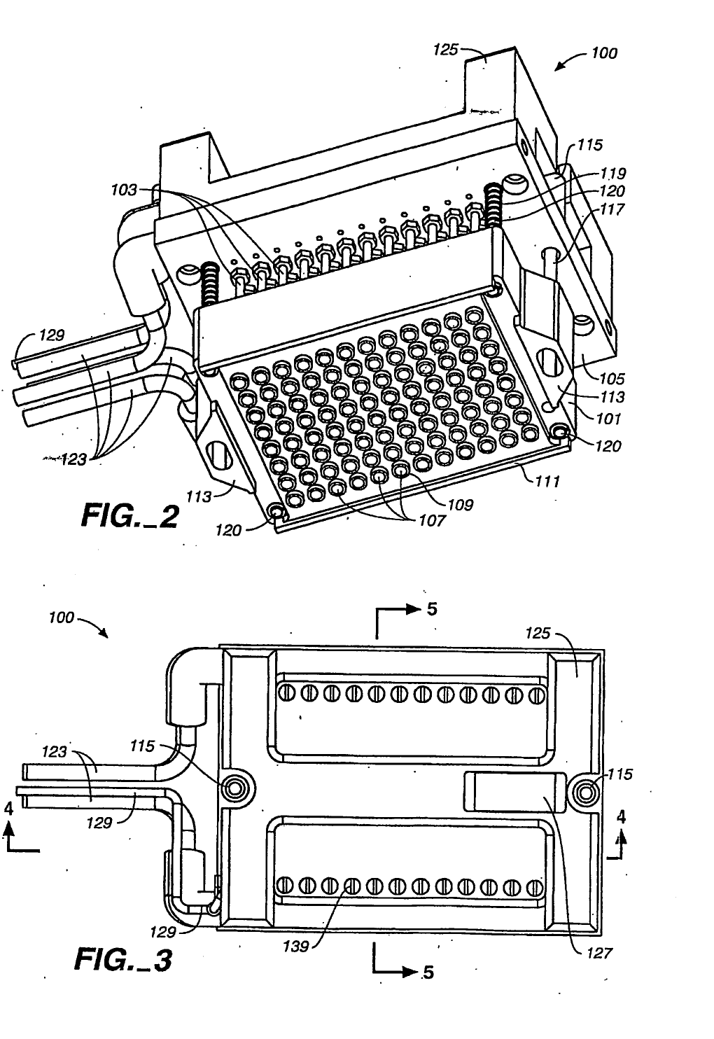

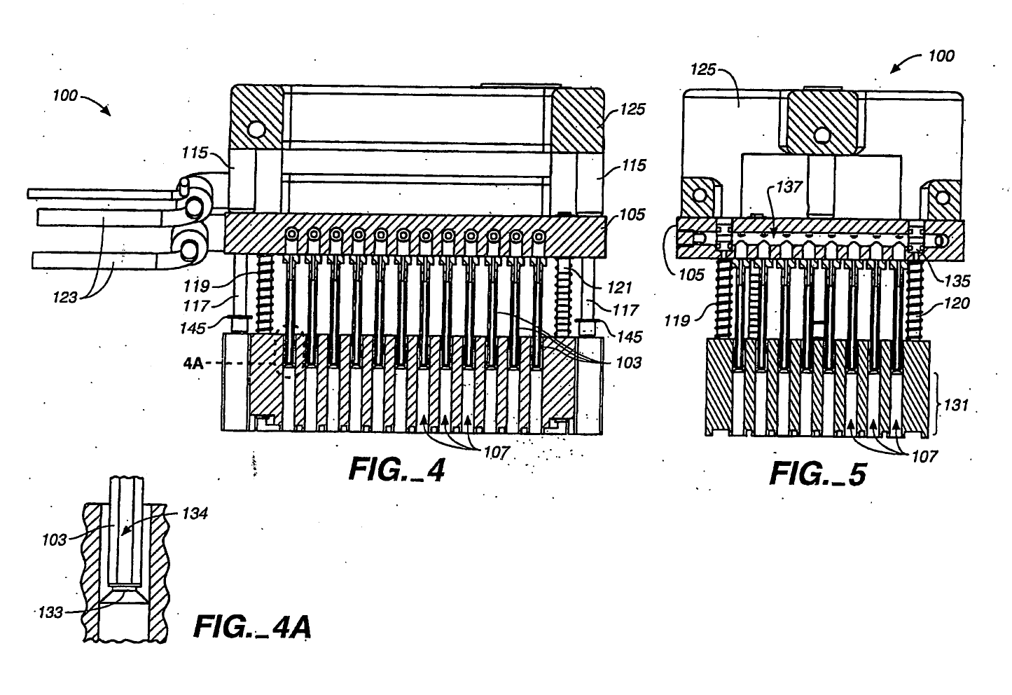

FIGS. 1-7 show various views of an exemplary resin handler, 100, of the invention. Resin handler 100 is used to collect a plurality of measured quantities of a powdered material and deliver each of the measured quantities to a corresponding vessel or well of a multi-well vessel. Each individual measured quantity is collected (via vacuum) in, and dispensed from, a collection cavity 107 (see also FIGS. 2 and 4). In this example, resin handler 100 is a hand held unit in fluid and electrical communication with a controller (remote, not shown). Apparatus of the invention require a vacuum source for collecting powdered materials; however in this example; the controller contains a vacuum source, a positive pressure source, electrical solenoids for controlling the vacuum and positive pressure sources, etc.

One skilled in the art would understand that resin handlers of the invention can also be automated units and/or self-contained units with an associated logic for automatically controlling resin handling functions described in this example as hand operations. Such embodiments will include components (such as robotic arms, tracks, and the like) to move and otherwise manipulate (for example as described below) a resin handler similar to resin handler 100.

FIG. 1 shows a top perspective of resin handler 100. Resin handler 100 has a collection member 101, which in this case is made from a block of rigid material. Preferred rigid materials for the collection member include but are not limited to plastics, metals, and the like. Powdered materials are often affected by static charge and can thus be hard to handle. In a particularly preferred embodiment, the collection member includes an anti-static material. Preferably the anti-static material includes at least one of a plastic, a metal, a glass, and a ceramic.

Referring to FIGS. 2, 4 and 5, collection member 101 has a plurality of collection cavities, 107, therein. Each of collection cavities 107 is formed by a combination of a hole in collection member 101 that is slidably engage-able with a plunger 103. FIGS. 4 and 5 cross-sections of resin handler 100, showing that the volume of collection cavities 107 is determined by the relative position (as measured by distance 131) of plungers 103 within the holes in collection member 101. Preferably each of the collection cavities is capable of holding between about 0.005 cm³ and 2 cm³ of the powdered material, more preferably between about 0.01 cm³ and 1 cm³ of the powdered material, and most preferably between about 0.1 cm³ and 0.5 cm³ of the powdered material. Preferably, apparatus of the invention are capable of collecting each of the measured quantities of the powdered material to within about ±0.1 cm³, more preferably to within about ±0.005 cm³, and most preferably to within about ±0.001 cm³.

One skilled in the art would understand that the collection member can take other shapes and configurations depending on the distribution of the receiving vessels that are to be used. Preferably the plurality of collection cavities are configured on collection member such that when the collection member is registered with a multi-well vessel, each cavity of the plurality of collection cavities is positioned to dispense its corresponding quantity, of the plurality of measured quantities of powdered material, into a corresponding well of the multi-well vessel. Preferably the multi-well vessel includes at least one of an 8-well format vessel, a 24-well format vessel, a 96-well format vessel, a 384-well format vessel, and a 1536-well format vessel.

In this example, plungers 103 are moved within the holes of collection member 101 in unison, however the invention is not limited in this way. Other embodiments of the invention have collection cavities whose volume can be varied independently. An analogy to this example would include independently movable plungers 103, although one skilled in the art would understand that other mechanisms for volume adjustment are included within the scope of the invention.

Preferably, but not necessarily, resin handlers of the invention include such dynamic volume adjustment as described above, that is, apparatus wherein no parts of the apparatus need be changed out in order to adjust the cavity volumes. For example, in an alternative embodiment, a flexible membrane is positioned over a plurality of deformation cavities, the membrane including a plurality of filter elements, each registered with a corresponding deformation cavity. For example, the membrane can be perforated to form such filter elements, or the membrane can be made of a material, for example a woven fabric, that serves both deformation and filtration functions. A vacuum source applied from within each deformation cavity (i.e. a pressure differential on either side of the membrane) serves to warp or deform the membrane into the deformation cavity and collect a powder into the concave portions of the flexible membrane thus formed. Upon release of vacuum the membrane reforms to its original shape (substantially flat) and expels each of the individual quantities of collected powder. In one embodiment the membrane deforms to meet with the interior surface of each of the plurality of deformation cavities, thus the cavities define the volume of powder collected. In another embodiment, the deformation cavities have a volume that the deformed membrane is unable to match, that is, the membrane can be variably deformed within each of the plurality of deformation cavities (e.g. via variable vacuum to each cavity) to thus collect various desired quantities of powder rather than being restricted to the volume defined by deformation to match the volume of the deformation cavities. In a particularly preferred embodiment, a single member contains the plurality of deformation cavities. In another particularly preferred embodiment vacuum can be applied independently (and variably) to each deformation cavity of the matrix of deformation cavities.

In an alternative embodiment, the flexible membrane is warped or deformed mechanically, at each desired collection cavity formation area, via mechanical force. Such mechanical force preferably includes a pulling force applied via an arm, wire, tube (e.g. used to supply vacuum to form a cavity) or other similar device or combinations thereof affixed to the membrane. When the pulling force is applied, and for example in combination with a localized member (for example a perforated member between the membrane and a vacuum source) to hold at least a portion of the membrane in its original orientation, a collection cavity is formed in the membrane, at each attachment point of such a mechanical device as the aforementioned. A vacuum is applied via the vacuum source in order to fill each collection cavity with powder. Again, upon release of vacuum the membrane reforms to its original shape (substantially flat) and expels each of the individual quantities of collected powder. By using mechanical force, the function of the vacuum source does not include deformation of the membrane, but rather collecting, holding, and optionally expelling powder. By decoupling the membrane deformation function from the vacuum source, flexibility is added to the collection process and devices used for collection.

Again referring to FIGS. 4 and 5, powder is collected in cavities 107 via a vacuum source. As depicted, in the face of each plunger 103 serves as a portion of the interior surface of each cavity 107. Referring to FIG. 4A, the face of each plunger 103 includes a filter 133. In this example, each of plungers 103 includes a hollow tube that serves as a conduit (see 134) for fluid communication with the vacuum source, and a filter 133 that is part of an insert assembly that engages with each tube. In this example, the insert assembly and corresponding filter 133 travel with the tube as it is moved within its corresponding hole in the collection member.

Each plunger 103 is attached to, and in fluid communication with, a manifold 105. Manifold 105 is in fluid communication with the vacuum or positive pressure source (in this example, both in a remote controller as described above) via fluid communication lines 123. Filter 133 substantially prevents powdered material from entering the interior of plungers 103 (and the vacuum source via manifold 105 and lines 123) during powder collection into cavities 107. Preferably, filter 133 is capable of excluding particles with an average particle size of between about 1 μm and 1000 μm, more preferably between about 1 μm and 500 μm, and most preferably between about 10 μm and 500 μm. Preferably filters of the invention include at least one of a semi-rigid screen, a sieve, a collection of micro-tubes, perforated ceramic, perforated plastic, perforated glass, a porous cermet, and a porous metal.

Thus, powder is collected into cavities 107 by application of a vacuum from within each of cavities 107. The volume of each of cavities 107 is adjusted by positioning the plungers appropriately within each cavity. Powder is dispensed from cavities 107 by shutting off (via a control valve, not shown) fluid communication between the vacuum source and each of the cavities from which powder is to be dispensed. One skilled in the art would understand that any number of combinations of cavity volume and all or a sub-set of the collection cavities can be used to both collect and dispense the powdered material, and such combinations do not escape the scope of the invention.

Although this exemplary apparatus has both vacuum and positive pressure capability, the invention need only have a vacuum source and a valve to cut off fluid communication between the vacuum source and the collection cavities (e.g. via manifold 105). Preferably the vacuum and positive pressure source are capable of providing both high and low vacuum and pressure, respectively. In this example, there are four fluid communication lines 123, but depending on the design of manifold 105, theoretically there need only be a single fluid communication line to a manifold of the invention. In this example, a plurality of lines is used to establish a desirable fluid distribution within manifold 105 specific to particular resin handling applications.

Manifold 105 is attached to a handle 125. Within handle 125 is an electrical communication line 129 for sending signals to solenoids (in the controller) for controlling the valves that regulate pressure within manifold 105 via a switch, 127, in handle 125. Switch 127 is conveniently thumb-operated while resin handler 100 is held via handle 125. In this embodiment, switch 127 has three positions, vacuum, off, and positive pressure. Vacuum is used to draw a powdered material into a selected number (all or a subset) of collection cavities 107 and positive pressure may be used to push powdered material out of the cavities for dispensing or as a cleaning aide. Preferably a push gas is used, the push gas preferably including at least one of air and an inert gas.

Referring to FIG. 2, each of the collection cavities has a guide, 109, at its aperture. Guide 109 aides in alignment of each collection cavity with a corresponding well of a multi-well vessel or a corresponding vessel of a plurality of vessels, when the collection member is engaged with such vessels. Included also in this example, are guides 111 and 113 for aiding alignment of collection member 101 with, for example, the upper edges around the perimeter of a 96-well vessel. In this example, there are 96 collection cavities 107, however the invention is not limited in this way.

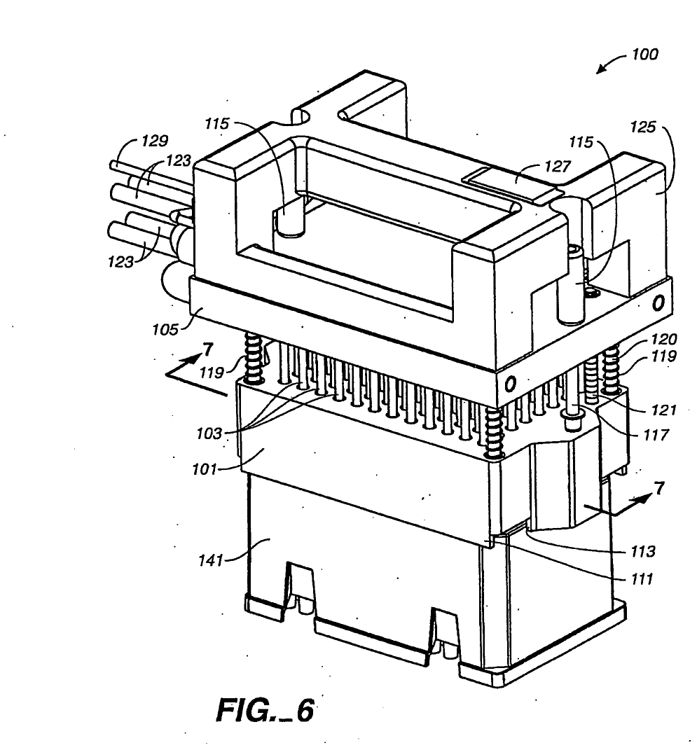

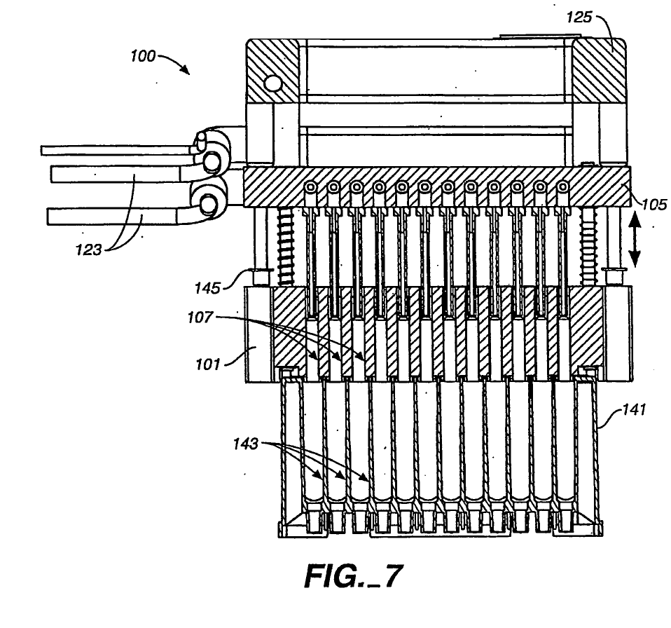

FIG. 6 is a perspective of resin handler 100 registered with a 96-well vessel, 141. Vessel 141 is a multi-well apparatus for chemical and biological analysis and synthesis, and is described in more detail in U.S. patent application Ser. No. 10/094,253, filed on Mar. 8, 2002, naming David C. Hager, et al as inventors, entitled, “Multi-well Apparatus,” which is incorporated by reference herein for all purposes. As depicted in FIG. 6, when resin handler 100 (more specifically collection member 101) is registered with vessel 141, guides 111 and 113 extend over the topmost outer perimeter of vessel 141. FIG. 7 is a cross-section of resin handler 100 registered with vessel 141, showing that guides 109 extend part way into the aperture of wells 143 of vessel 141, and thus not only aide in alignment but also ensure delivery of powdered material from each cavity into its corresponding well, since each collection cavity is registered with a specific well via its corresponding guide 109.

Referring to FIG. 2, posts 120 are affixed to collection member 101, passing through holes in the member and into holes through manifold 105 and handle 125. The handle and manifold assembly is slidably engage-able with posts 120. Springs 119 (refer also to FIGS. 1, 2, and 4-6) are concentric to posts 120 and provide resistance to movement of the handle and manifold assembly toward collection member 101. Thus, when resin handler 100 is engaged with a reaction vessel (as depicted in FIGS. 6 and 7) and sufficient downward force (to compress springs 119) on handle 125 is applied, the handle/manifold assembly slides on posts 120 and pushes plungers 103 to displace material with collection cavities 107. A stop, 145, is used to prohibit movement of the manifold's bottom face beyond the level of the stop. When such a downward force applied to handle 125 is released, springs 119 return the handle/manifold assembly (and plungers 103) back to their original position. Thus, the handle/manifold assembly is capable of sliding bi-directionally along posts 120. See heavy double-headed arrow in FIG. 7 indicating range of bi-directional movement.

Thus powdered material is delivered from cavities 107 by one of three mechanisms or combinations thereof: cutting off vacuum (i.e. return to atmospheric pressure followed by gravity pulling the powder out of each cavity), positive pressure push, and physical displacement via plungers 103. Again, apparatus of the invention need only include the first mechanism, but may include any combination of the three mechanisms. Depending on the powdered material and application, any or all of these displacement mechanisms may be desirable.

Resin handlers of the invention include an adjustment mechanism for dynamically adjusting the volume of the collection cavities. In this example, the volume of collection cavities 107 is adjusted via positioning each plunger 103 within its respective hole in collection member 101. Lead screws 117 are affixed to collection member 101 and extend through manifold 105. At the top of each lead screw 117 is an adjustment thumbscrew 115. When thumbscrews 115 are turned in the appropriate direction on the threads (not shown) on lead screw 117, this applies downward force (directly opposing the upward force supplied by springs 119) onto the manifold pushing it along posts 120 toward collection member 101, thus adjusting the position of plungers 103 within their respective holes in the collection member. As mentioned, springs 119 provide sufficient force to maintain a fixed distance between the handle/manifold assembly and collection member 101; this force can be overcome, for example, by downward force delivered to handle 125. One skilled in the art would appreciate that automated cavity volume adjustment mechanisms are also within the scope of the invention. Preferably the adjustment mechanism includes at least one of a lead screw, and a pneumatic cylinder.

In this example, the adjustment mechanism includes a graduated cylinder, 121, used to demark the position of the bottom face of manifold 105. As mentioned, the manifold's position, 131 (refer to FIG. 5), relative to collection member 101, determines the position of each of plungers 103 in its respective hole in the collection member, and thus the volume of each of the corresponding cavities 107. The graduations on cylinder 121 are configured, in this example, to demark pre-set collection cavity volumes. For example, the horizontal demarcations on cylinder 121 indicate collection cavity volumes in a linear format; e.g. 0.1, 0.2, 0.3, and so on, up to 1.0 cm³ of powder.

As mentioned, resin handler 100 is used to collect and dispense all or a sub-set of 96 measured quantities of a powdered material. Referring to FIG. 5, resin handler 100 includes a plurality of valves 135 within manifold 105. Valves, 135, control fluid communication between the vacuum or positive pressure source (via the controller and its corresponding valves) and manifold 105. In this example, each column of 8 (versus rows of 12) collection cavities 107 is in fluid communication with a separate plenum 137 via two valves 135 (one at each end of the column's corresponding manifold chamber). In this example there are 24 valves 135, two for each column of eight collection cavities 107 (and each column's corresponding plenum). Fluid communication between the vacuum or positive pressure source and each plenum 137 is terminated via its two corresponding valves 135. Each valve 135 is adjusted, in this case turned, via a slot, 139, in its head. See FIG. 3. Thus, appropriate adjustment of valves 135 allows all or a subset of collection cavities 107 to be used to collect and dispense a powdered material.

One skilled in the art would recognize that other configurations of manifolds and similar mechanisms fall within the scope of the invention. For example, manifold 105 could be valved such that any combination of rows and columns in a matrix of collection cavities can be used to collect and dispense a powder material. As well, the plurality of collection cavities can be positioned in any number of ordered (e.g. concentric rows) or random arrays, either aligned in a single plane as in this example, or out of plane with each other, such as a staggered vertical arrangement such as on a curved surface of a collection member.

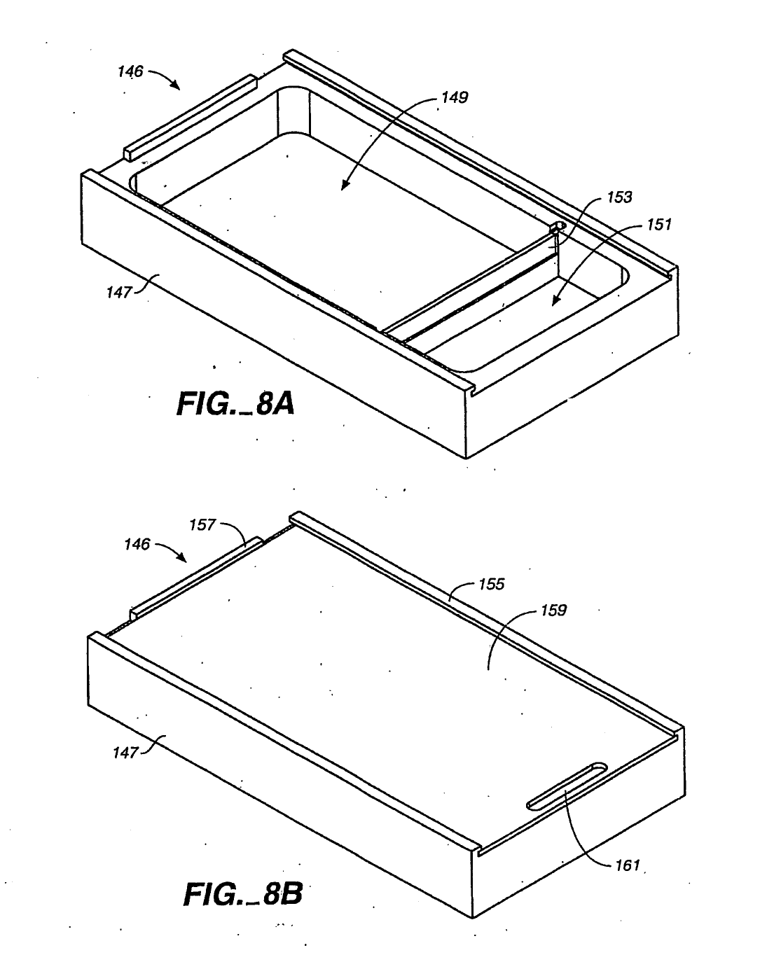

As mentioned, resin handler 100 is an example of a hand held apparatus of the invention. Another aspect of the invention is a supply bin for holding a powdered material that is collected and dispensed using, for example, resin handler 100. FIG. 8A is a perspective of such a supply bin, 146, of the invention. Supply bin 146 includes a powder compartment, 149, sized and shaped to accommodate a supply of the powdered material and the collection member when collecting the powdered material in collection cavities 107. For example, resin handler 100 is positioned in the supply of powdered material, and the powdered material is collected via vacuum into all or a subset of collection cavities 107. Preferably all of the desired collection cavities are filled simultaneously, for example with the single push of switch 127.

In some cases, a portion of the powdered material protrudes beyond the aperture of collection cavities during collection due to for example the vacuum applied to the collection cavities. Supply bin 146 includes a squeegee, 153, configured to remove at least a portion of the powdered material that protrudes beyond the aperture of each of the collection cavities, when the collection cavities and the squeegee are moved across one another. Preferably this is done in a motion that allows the removed portions of the powder to fall back into powder compartment 149. Supply bin 146 also includes a powder catch compartment, 151, configured to catch any of the powdered material that does not fall back into the powder compartment when the collection cavities and the squeegee are moved across one another.

FIG. 8B depicts a lid, 159, for supply bin 146. Supply bin 146 includes guides 155 for receiving lid 159, and a stop 157, both to ensure proper alignment when lid 159 is engaged with supply bin 146. Lid 159 is particularly useful when using powdered material that is hygroscopic. Preferably lid 159 and supply bin 146 form a substantially fluid-tight seal when engaged. One skilled in the art would understand that formation of such a fluid-tight seal may include use of a sealing member, such as a gasket (not shown). Supply bin 146 may also include a mechanism for removing air from the interior of the bin when lid 159 is in place. Such a mechanism preferably includes mechanisms for applying a vacuum to the interior of the closed supply bin or passing an inert gas through the interior volume to displace any air and/or moisture therein. Automated resin handling systems of the invention, as described above, preferably have the resin handler and supply bin in a self-contained controlled atmosphere environment. In one example, such an automated system includes a forced air ventilation system to remove any airborne particles and or volatile chemicals associated with applications for which the powdered material is needed, such as chemical synthesis in parallel. As such automated resin handling systems of the invention can be part of a larger system, for example a parallel synthesizer. In a particularly preferred embodiment, resin handlers of the invention are modular components of a larger synthesis or assay system.

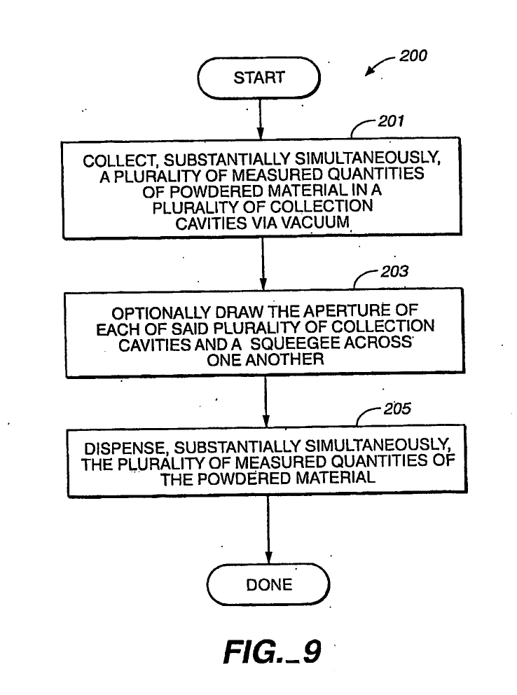

As mentioned, another aspect of the invention is method of collecting and dispensing a powdered material. FIG. 9 is a flowchart depicting aspects of a method, 200, of the invention. Method 200 starts with collecting, substantially simultaneously, a plurality of measured quantities of the powdered material in a plurality of collection cavities, wherein each of the plurality of collection cavities is in fluid communication with, via an inlet within each cavity, a vacuum source. See block 201. One skilled in the art would understand that collection of the powdered material into the cavities may occur with finite variation in timing. That is, in some instances depending upon mechanical limitations or choice, each of the plurality of measured quantities of the powdered material may be collected sequentially or randomly, wherein the timing of each collection varies only by a very small amount of time such as a fraction of a second. For reasons of throughput, it is preferable to collect the plurality of measured quantities of the powdered material simultaneously, although sequential collections, for example collecting 96 samples in a very short period of time (on the order of seconds or a fraction of a second) do not escape the scope of the invention.

Preferably each of the plurality of collection cavities includes a filter (as described above) to substantially prevent the powdered material from entering the inlet. Preferably the filter is capable of excluding particles with an average particle size of between about 1 μm and 1000 μm, more preferably between about 1 μm and 500 μm, and most preferably between about 10 μm and 500 μm.

In some embodiments, the volume of each of the plurality of collection cavities is dynamically adjusted during collection. That is, with certain powders, it is advantageous to increase the volume (up to a desired volume) of each of the collection cavities during collection. One scenario where this is advantageous is when the particle diameter of the powdered material is of sufficient magnitude that one or more particles can lodge in the cavity and block further entry of particles. If the collection cavity volume is dynamically adjusted during collection (as described above), it helps to ensure that the powdered material is collected in the cavity starting at what will be the innermost surface of the cavity, e.g. the face of a plunger as described above, and incrementally stacked as the volume of the cavity is increased, without blockage during collection. Preferably each of the plurality of collection cavities is capable of holding between about 0.005 cm³ and 2 cm³ of the powdered material, more preferably between about 0.01 cm³ and 1 cm³ of the powdered material, and most preferably between about 0.1 cm³ and 0.5 cm³ of the powdered material.

As mentioned above, in some embodiments it is desirable to collect varying amounts of a powdered substance in each of the collection cavities, for example, when the powder is a reagent used for a biological assay or chemical synthesis and the amount of powder needed to reach a certain reaction kinetic or carry out a particular stoichimetric conversion is to be studied. In these cases it is desirable to have a system (as described above) or method that provides dynamically adjustable collection cavities. Methods of the invention also allow such variation in collection volume. For example, when the volume of the collection cavities is held constant, methods of the invention include collecting, substantially simultaneously, the plurality of measured quantities of the powdered material by varying the vacuum applied to each of the cavities, rather than using varying cavity volume and filling the cavities to capacity as described above. In one example, the vacuum applied to the collection cavities is varied across a matrix of cavities (as in resin handler 100) by establishing a vacuum gradient among the cavities. In one example, this is done by choice of manifold design and/or configuration of fluid communication of the vacuum source with the manifold. For example, if fluid communication between manifold 105 (see FIGS. 1-7) and a vacuum source is established appropriately, for example from a single source line at one end of the manifold, then a vacuum gradient may be generated that will collect smaller amounts of powder in collection cavities further from the vacuum source inlet in the manifold than those cavities in closer proximity to the vacuum source inlet. Depending on the powder being collected, the vacuum, depth of cavities, etc., varying measured amounts of the powder are collected to make up the plurality of measured quantities of the powdered material as described in FIG. 9, block 201.

Preferably the plurality of collection cavities are configured on a collection member such that when the collection member is registered with a multi-well vessel, each cavity of the plurality of collection cavities is configured to dispense its corresponding quantity, of the plurality of measured quantities of powdered material, to a corresponding well of the multi-well vessel. Preferably the multi-well vessel includes at least one of a 96-well format vessel, a 384-well format vessel, and a 1536-well format vessel.

Once the plurality of measured quantities of the powdered material are collected, it may be preferable to move a squeegee and the aperture of each of the plurality of collection cavities across each other, to remove at least a portion of the powdered material that protrudes beyond the aperture of each of the plurality of collection cavities. See block 203. For powders of small average particle size, and depending on the vacuum applied, a typically conical portion of the powder will protrude beyond at least some of the apertures of the collection cavities. For obtaining consistency in the weight of each measured quantity, removing the portions that protrude beyond the apertures as described is preferable, although not necessary. Preferably the portion of the powdered material that is removed, by moving the squeegee and the aperture of each of the plurality of collection cavities across each other, is collected for reuse.

After the plurality of measured quantities are collected and any unwanted material removed via squeegee, the measured quantities are dispensed. See block 205. Preferably dispensing the measured quantities is done substantially simultaneously, by terminating fluid communication between each of the plurality of collection cavities and the vacuum source while each of the plurality of collection cavities is oriented such that gravity pulls each of the plurality of measured quantities of the powdered material out of each of the plurality of collection cavities. In addition, or alternatively, dispensing the powdered material may include a positive pressure push of a gas (typically air, but in some cases preferably an inert gas) or a physical push via, for example, a plunger as described above. After the measured quantities of the powdered material are dispensed, the method is done.

In some embodiments only a sub-set of the plurality of collection cavities are used to collect and dispense the powdered material. In a preferred embodiment, the plurality of collection cavities are arranged in a matrix, and the sub-set includes one or more rows, one or more columns, or combinations thereof of the matrix.

As described above, one way of performing methods of the invention is using a hand-held unit that includes the plurality of collection cavities. Also preferable is using an automated mechanism configured to collect the powdered material in all or the sub-set of the plurality of collection cavities, move the aperture of each of the plurality of collection cavities and the squeegee across one another, and deliver each of the plurality of measured quantities of the powdered solid, via the plurality of collection cavities, to a plurality of vessels corresponding to all or the sub-set of the plurality of collection cavities containing the powdered material. This is particularly true in very high-throughput environments such as automated combinatorial chemistry or biological screening.

While this invention has been described in terms of a few preferred embodiments, it should not be limited to the specifics presented above. Many variations on the above-described preferred embodiments, can be employed. Therefore, the invention should be broadly interpreted with reference to the following claims.

What is claimed is:

1. An apparatus for automatically collecting, substantially simultaneously, a plurality of measured quantities of a powdered material and dispensing, substantially simultaneously, each of the plurality of measured quantities of the powdered material, the apparatus comprising:
(a) a plurality of collection cavities, each of said collection cavities comprising an inlet for fluid communication therein and a filter configured to prevent the powdered material from entering;
(b) a vacuum source, said vacuum source connected to each of the plurality of collection cavities via the inlet therein; and
(c) a control valve configured to establish or terminate fluid communication between the vacuum source and each of the plurality of collection cavities.

2. The apparatus of claim 1, wherein the volume of each of the plurality of collection cavities is dynamically adjustable.

3. The apparatus of claim 2, wherein the plurality of collection cavities are configured on a collection member such that when the collection member is registered with a multi-well vessel, each cavity of the plurality of collection cavities is positioned to dispense its corresponding quantity, of the plurality of measured quantities of the powdered material, into a corresponding well of the multi-well vessel.

4. The apparatus of claim 3, wherein the multi-well vessel comprises at least one of an 8-well format vessel, a 24-well format vessel, a 96-well format vessel, a 384-well format vessel, and a 1536-well format vessel.

5. The apparatus of claim 2, wherein each of the plurality of collection cavities is capable of holding between about 0.005 cm³ and 2 cm³ of the powdered material.

6. The apparatus of claim 2, wherein each of the plurality of collection cavities is capable of holding between about 0.01 cm³ and 1 cm³ of the powdered material.

7. The apparatus of claim 2, wherein each of the plurality of collection cavities is capable of holding between about 0.1 cm³ and 0.5 cm³ of the powdered material.

8. The apparatus of claim 3, wherein said collection member comprises:
(i) a plurality of holes, said plurality of holes slidably engage-able with;
(ii) a plurality of plungers, each of said plurality of plungers comprising a tube, open at both ends, said filter affixed at the end of the tube that comes in proximity to the powdered material during collection and the other end of the tube in fluid communication with the vacuum source;
wherein the volume of each of the plurality of collection cavities is defined substantially by the volume from the aperture of its corresponding hole to the face of its corresponding plunger.

9. The apparatus of claim 8, wherein the filter is capable of excluding particles with an average particle size of between about 1 μm and 1000 μm.

10. The apparatus of claim 9, wherein the filter is capable of excluding particles with an average particle size of between about 1 μm and 500 μm.

11. The apparatus of claim 9, wherein the filter is capable of excluding particles with an average particle size of between about 10 μm and 500 μm.

12. The apparatus of claim 9, wherein the filter comprises at least one of a semi-rigid screen, a sieve, a collection of micro-tubes, a perforated ceramic, a perforated plastic, a perforated glass, a porous cermet, and a porous metal.

13. The apparatus of claim 9, wherein the plurality of plungers are affixed to and in fluid communication with a manifold, said manifold serving to establish fluid communication between each of the plurality of plungers and the vacuum source.

14. The apparatus of claim 13, wherein the manifold further comprises a plurality of valves, said plurality of valves configured such that fluid communication between the vacuum source and all or a sub-set of the plurality of collection cavities can be shut off.

15. The apparatus of claim 14, wherein the plurality of collection cavities are arranged in a matrix, and the sub-set comprises one or more rows, one or more columns, or combinations thereof of said matrix.

16. The apparatus of claim 13, wherein the relative position of each plunger within its corresponding hole is established by an adjustment mechanism configured to vary the distance between the manifold and the collection member.

17. The apparatus of claim 16, wherein each plunger is capable of displacing each of the plurality of measured quantities of the powdered material from the corresponding hole wherein said each plunger resides.

18. The apparatus of claim 16, wherein the adjustment mechanism comprises at least one of a lead screw and a pneumatic cylinder.

19. The apparatus of claim 14, further comprising a controller, said controller comprising:
(a) a plurality of solenoids for controlling the control valve and said plurality of valves;
(b) the vacuum source;
(c) a positive pressure source for delivering a positive pressure of a gas; and
(d) an associated logic configured to automatically control the plurality of solenoids based on a manual switch control, a pre-programmed algorithm, or both;
wherein the control valve, the plurality of valves, and combinations there of are used to control fluid communication between each of the collection cavities, via their respective inlets, and either the vacuum source or the positive pressure source.

20. The apparatus of claim 19, wherein the vacuum source is capable of producing both a high vacuum and a low vacuum, and the positive pressure source is capable of delivering both a high-pressure flow of the gas and a low-pressure flow of the gas.

21. The apparatus of claim 20, wherein the gas comprises at least one of air and an inert gas.

22. The apparatus of claims 19, further comprising a supply bin for holding the powdered material, said supply bin comprising:
(a) a powder compartment sized and shaped to accommodate a supply of the powdered material and the collection member when collecting the powdered material in the plurality of collection cavities therein; and
(b) a squeegee configured to remove at least a portion of the powdered material that protrudes beyond the aperture of each of the plurality of collection cavities, during collection, when the aperture of each of the plurality of collection cavities and the squeegee are moved across one another.

23. The apparatus of claim 22, configured such that the portion of the powdered material that protrudes beyond the aperture of each of the plurality of collection cavities, after removed by said squeegee, is returned into the powder compartment.

24. The apparatus of claim 23, further comprising a powder catch compartment configured to catch any of the powdered material that does not fall back into the powder compartment when the aperture of each of the plurality of collection cavities and the squeegee are moved across one another.

25. The apparatus of claim 19, wherein the collection member, the manifold, and the manual switch control are combined in a hand-held unit, said hand-held unit in electrical and fluid communication with the controller.

26. The apparatus of claim 19, further comprising an automated mechanism configured to collect the powdered material in all or the sub-set of the plurality of collection cavities, move the aperture of each of the plurality of collection cavities and the squeegee across one another, and deliver each of the plurality of measured quantities of the powdered solid, via the plurality of collection cavities, to a plurality of vessels corresponding to all or the sub-set of the plurality of collection cavities containing the powdered material.

27. The apparatus of claim 3, wherein at least one of the collection member and each of the plurality of collection cavities comprise an anti-static material.

28. The apparatus of claim 27, wherein the anti-static material comprises at least one of a plastic, a metal, a glass, and a ceramic.

29. The apparatus of claim 8, wherein the collection member further comprises a plurality of guides, each guide of said plurality of guides residing at the aperture of each of the plurality of collection cavities, each guide of said plurality of guides configured to aide in registration of its corresponding collection cavity with a receiving vessel.

30. The apparatus of claim 29, wherein the collection member further comprises an alignment guide, said alignment guide configured to aide in registration of the collection member with the multi-well vessel.

31. The apparatus of claim 5, capable of collecting each of the plurality of measured quantities of the powdered material to within about ±0.1 cm³.

32. The apparatus of claim 5, capable of collecting each of the plurality of measured quantities of the powdered material to within about ±0.005 cm³.

33. The apparatus of claim 5, capable of collecting each of the plurality of measured quantities of the powdered material to within about ±0.001 cm³.

34. A method of collecting and dispensing a powdered material, the method comprising:
(a) collecting, substantially simultaneously, a plurality of measured quantities of the powdered material in a plurality of collection cavities, wherein each of said plurality of collection cavities is in fluid communication with, via an inlet within each cavity, a vacuum source; and
(b) dispensing, substantially simultaneously, the plurality of measured quantities of the powdered material by terminating, substantially simultaneously, fluid communication between each of said plurality of collection cavities and the vacuum source while each of the plurality of collection cavities is oriented such that gravity pulls each of the plurality of measured quantities of the powdered material out of each of the plurality of collection cavities;
wherein each of the plurality of collection cavities comprises a filter to substantially prevent said powdered material from entering its corresponding inlet.

35. The method of claim 34, wherein the volume of each of the plurality of collection cavities is dynamically adjusted during (a).

36. The method of claim 34, further comprising applying a positive pressure of a gas to each of said collection cavities, via the inlet within each cavity, to facilitate removal of each of the plurality of measured quantities of the powdered material therein.

37. The method of claim 36, wherein the gas comprises at least one of air and an inert gas.

38. The method of claim 34, wherein the plurality of collection cavities are configured on a collection member such that when the collection member is registered with a multi-well vessel, each cavity of the plurality of collection cavities is configured to dispense its corresponding quantity, of the plurality of measured quantities of powdered material, to a corresponding well of the multi-well vessel.

39. The method of claim 38, wherein the multi-well vessel comprises at least one of an 8-well format vessel, a 24-well format vessel, a 96-well format vessel, a 384-well format vessel, and a 1536-well format vessel.

40. The method of claim 34, wherein each of the plurality of collection cavities is capable of holding between about 0.005 cm³ and 2 cm³ of the powdered material.

41. The method of claim 34, wherein each of the plurality of collection cavities is capable of holding between about 0.01 cm³ and 1 cm³.

42. The method of claim 34, wherein each of the plurality of collection cavities is capable of holding between about 0.1 cm³ and 0.5 cm³ of the powdered material.

43. The method of claim 34, wherein the filter is capable of excluding particles with an average particle size of between about 1 μm and 1000 μm.

44. The method of claim 34, wherein the filter is capable of excluding particles with an average particle size of between about 1 μm and 500 μm.

45. The method of claim 34, wherein the filter is capable of excluding particles with an average particle size of between about 10 μm and 500 μm.

46. The method of claim 34, wherein a sub-set of the plurality of collection cavities are used to collect the powdered material during (a) and dispense the powdered material during (b).

47. The method of claim 46, wherein the plurality of collection cavities are arranged in a matrix, and the sub-set comprises one or more rows, one or more columns, or combinations thereof of the matrix.

48. The method of claim 34, further comprising moving a squeegee and the aperture of each of the plurality of collection cavities across each other, to remove at least a portion of the powdered material that protrudes beyond the aperture of each of the plurality of collection cavities, after (a) and before (b).

49. The method of claim 48, wherein the portion of the powdered material that is removed, by moving the squeegee and the aperture of each of the plurality of collection cavities across each other, is collected for reuse.

50. The method of claim 48, performed using a hand-held unit, said hand held unit comprising the plurality of collection cavities.

51. The method of claim 48, performed using an automated mechanism configured to collect the powdered material in all or the sub-set of the plurality of collection cavities, move the aperture of each of the plurality of collection cavities and the squeegee across one another, and deliver each of the plurality of measured quantities of the powdered solid, via the plurality of collection cavities, to a plurality of vessels corresponding to all or the sub-set of the plurality of collection cavities containing the powdered material.

52. The method of claim 40, wherein each of the plurality of collection cavities is capable of collecting each of the plurality of measured quantities of the powdered material to within about ±0.1 cm³.

53. The method of claim 40, wherein each of the plurality of collection cavities is capable of collecting each of the plurality of measured quantities of the powdered material to within about ±0.005 cm³.

54. The method of claim 40, wherein each of the plurality of collection cavities is capable of collecting each of the plurality of measured quantities of the powdered material to within about ±0.001 cm³.

55. The method of claim 40, wherein the plurality of collection cavities is formed via deformation of a flexible membrane into a plurality of deformation cavities via at least a partial vacuum applied via each of said plurality of deformation cavities.

56. The method of claim 55, wherein said flexible membrane deforms to conform to interior surface of each of said plurality of deformation cavities, whereby the volume of each of said plurality of deformation cavities substantially defines the volume of the powdered material collected in the corresponding collection cavity formed therein.

57. The method of claim 55, wherein said flexible membrane deforms, but does not conform to the interior surface of each of said plurality of deformation cavities, whereby the volume of each of said plurality of collection cavities is defined substantially by the volume of the depression formed in the flexible membrane caused by deformation of said flexible membrane.

58. The method of claim 55, wherein upon release of said at least partial vacuum the flexible membrane reforms substantially to the shape it possessed prior to application of said at least partial vacuum, thereby expelling each of the individual quantities of the powdered material collected.
